(19) United States
(12) Patent Application Publication
(10) Pub. No.: US 2013/0067927 A1
(43) Pub. Date: Mar. 21, 2013

(54) SYSTEM AND METHOD FOR CONTROLLING COMBUSTION INSTABILITIES IN GAS TURBINE SYSTEMS

(71) Applicants: Joseph Kirzhner, Simpsonville, SC (US); Roy Marshall Washam, Clinton, SC (US)

(72) Inventors: Joseph Kirzhner, Simpsonville, SC (US); Roy Marshall Washam, Clinton, SC (US)

(73) Assignee: GENERAL ELECTRIC COMPANY, Schenectady, NY (US)

(21) Appl. No.: 13/234,493

(22) Filed: Sep. 16, 2011

(51) Int. Cl. F23R 3/28; F02C 9/00; F23R 3/42

(52) U.S. Cl. 60/773; 60/740; 60/746

(57) ABSTRACT

A gas turbine system and a method for controlling combustion instability in a combustion section of a gas turbine system are disclosed. The gas turbine system includes a compressor section, a turbine section connected to the compressor section, and a combustor section connected to the compressor section and the turbine section. The combustor section includes a plurality of combustors. The combustor section further includes at least one igniter for igniting a fuel-air mixture within each of the plurality of combustors into a hot gas. The gas turbine system further includes a control system for controlling a velocity of the hot gas in at least one of the plurality of combustors by controlling an operating parameter of the fuel-air mixture.

### FIELD OF THE INVENTION

The present disclosure is generally related to gas turbine systems, and more particularly to systems and methods for controlling combustion instabilities in gas turbine systems.

### BACKGROUND OF THE INVENTION

Gas turbine systems are widely utilized in fields such as power generation.

A conventional gas turbine system includes a compressor section, a combustor section, and a turbine section. In a conventional gas turbine system, compressed air is provided from the compressor section to the combustor section. The air entering the combustor section is mixed with fuel and combusted. Hot gases of combustion flow from the combustor section to the turbine section to drive the gas turbine system and generate power.

Recently, the development of flexible fuel gas turbine systems has improved the performance of such systems. Flexible fuel systems are adaptable to a wide range of fuels with various fuel compositions and heat capacities. These systems have led to improvements in power generation and efficiency and reductions in NOₓ emissions.

However, the development and use of flexible fuel gas turbine systems has led to increases in combustion instabilities during operation. For example, the use of highly reactive fuel blends has led to increases in combustion instabilities, such as combustion noise, flashback and/or flame holding, which can damage or destroy the combustor section and gas turbine system.

Thus, improved systems and methods for controlling combustion instabilities in a gas turbine system would be desired in the art.

### BRIEF DESCRIPTION OF THE INVENTION

Aspects and advantages of the invention are set forth below in the following description, or may be obvious from the description, or may be learned through practice of the invention.

In one embodiment, a gas turbine system is disclosed. The gas turbine system includes a compressor section, a turbine section connected to the compressor section, and a combustor section connected to the compressor section and the turbine section. The combustor section includes a plurality of combustors, each of the plurality of combustors including an outer shell defining a chamber therein. Each of plurality of combustors is in fluid communication with the compressor section for flowing air to each of the plurality of chambers and further includes at least one injector for injecting a fuel into the chamber such that the air and fuel form an air-fuel mixture. The combustor section further includes at least one igniter for igniting the fuel-air mixture within each of the plurality of combustors into a hot gas. The gas turbine system further includes a control system for controlling a velocity of the hot gas in at least one of the plurality of combustors by controlling an operating parameter of the fuel-air mixture.

In another embodiment, a method for controlling combustion instability in a combustion section of a gas turbine system is disclosed. The method includes determining a velocity of a hot gas in a combustor of the combustion section, and adjusting an operating parameter of the fuel-air mixture. The combustor includes an outer shell defining a chamber therein. The combustor is in fluid communication with a compressor section of the turbine system for flowing air to the chamber and further includes at least one injector for injecting a fuel into the chamber such that the air and fuel form an air-fuel mixture. The combustor section further includes at least one igniter for igniting the fuel-air mixture within the combustor into the hot gas.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a schematic illustration of a gas turbine system according to one embodiment of the present disclosure;

FIG. 2 is a schematic illustration of a gas turbine system according to another embodiment of the present disclosure;

FIG. 3 is a cross-sectional view of several portions of a gas turbine system according to one embodiment of the present disclosure;

FIG. 4 is a cross-sectional view of a combustor according to one embodiment of the present disclosure;

FIG. 5 is a cross-sectional view of a combustor according to another embodiment of the present disclosure;

FIG. 6 is a cross-sectional view of a combustor according to another embodiment of the present disclosure; and

FIG. 7 is a cross-sectional view of a combustor according to another embodiment of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

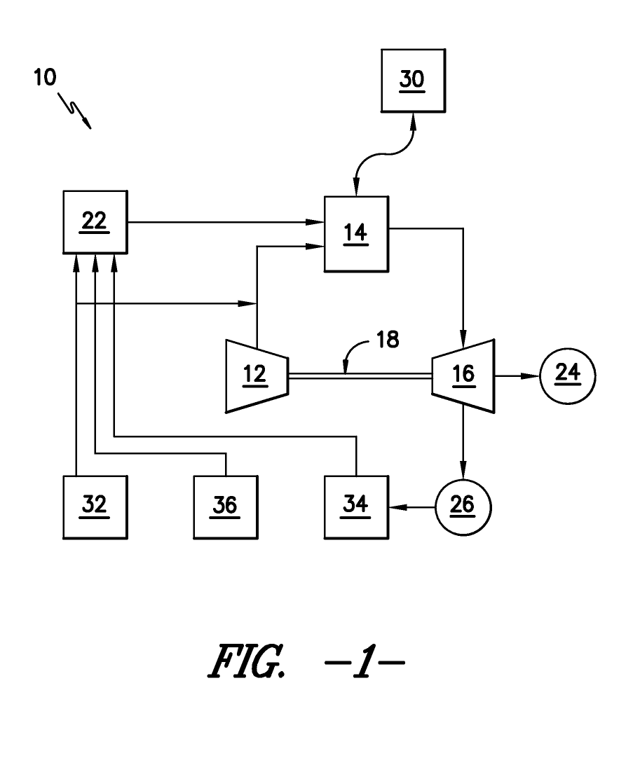

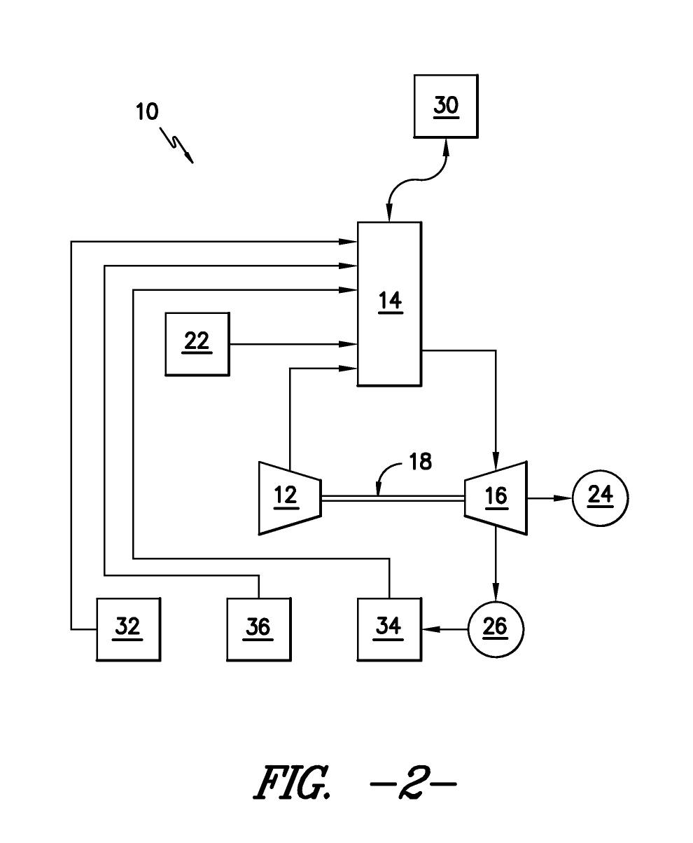

FIGS. 1 and 2 are schematic diagrams of various embodiments of a gas turbine system 10. The system 10 may include a compressor section 12, a combustor section 14, and a turbine section 16. The compressor section 12 and turbine section 16 may be coupled by a shaft 18. The shaft 18 may be a single shaft or a plurality of shaft segments coupled together to form shaft 18.

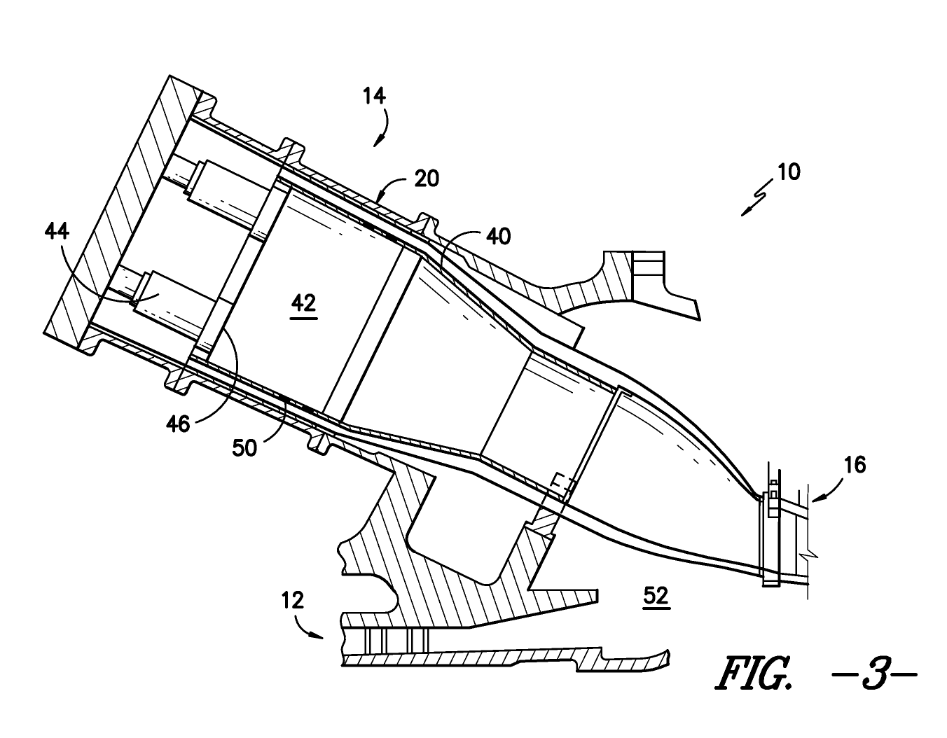

The combustor section 14 of a gas turbine system 10 may include a plurality of combustors 20, also known as combustor cans, (one of which is shown in each of FIGS. 3 through 7). Typically, the combustors 20 are positioned in an annular array about a central axis. As discussed below, air and fuel may be provided to each of the combustors 20 and mixed therein. Igniters (not shown) positioned in or adjacent to one or more of the combustors 20 may ignite the air-fuel mixture, causing combustion thereof into a hot gas.

Air is typically provided to the combustor section 14 from the compressor section 12 after being compressed, as is generally known in the art. Fuel may be provided to each of the combustors 20 in the combustor section from a fuel source 22. The fuel source may be any suitable source that provides a suitable fuel to the system 10. Suitable fuels according to the prevent disclosure include any suitable gas or liquid fuels, such as natural gas or an oil. Further, suitable fuels include fuels and fuel compositions that may be utilized in flexible fuel gas turbine systems, such as fuel compositions including hydrogen, relatively high amounts of hydrocarbons, and/or having relatively high lower heating values.

The system 10 may further include a generator 24. Power generated through operation of the compressor section 12, combustor section 14, and turbine section 16 is provided to and stored in the generator 24. In exemplary embodiments, the generator 24 is coupled to the compressor section 12 and turbine section 16 by the shaft 18. Exhaust gases may be exhausted into the atmosphere, to a suitable heat exchanger such as a heat recovery steam generator (“HRSG”) 26 as shown, or to any other suitable device or apparatus.

The gas turbine system 10 further includes various devices and apparatus for controlling combustion instabilities, such as combustion noise, flashback and/or flame holding. Control of such combustion instabilities will allow for reduction and control of the occurrences of the instabilities, thus allowing for safer operation of the system 10.

Thus, the present system 10 further includes a control system 30. The control system 30 controls the velocity of the combusted hot gas in one or more of the plurality of combustors 20. The present inventors have discovered that control of the velocity of such hot gases advantageously allows for control of combustion instabilities. For example, control of the velocity of the hot gas may further control various parameters of the hot gas flow that contribute to combustion instabilities, such as amplitude, frequency, and rate of change of combustion oscillations. Thus, control of the velocity of the hot gas is practical, efficient, and effective for controlling and minimizing combustion instabilities in a system 10.

The control system 30 may be communicatively coupled to the combustor section 14, and one or more combustors thereof, for controlling the velocity of combusted hot gases. The communicative coupling may be through a physical coupling, such as through a wire or other conduit or umbilical cord, or may be a wireless coupling, such as through an infra-red, cellular, sonic, optical, or radio frequency based coupling. The control system 30 may include a processor and suitable hardware and software for monitoring and controlling the velocity of a hot gas. The control system may be fully or partially manually operated, and/or may be fully or partially automated through the use of such hardware and software, such as suitable programming logic. The control system 30 may be included in a computer or other device suitable for operation of the control system 30.

The control system 30 controls the velocity of the hot gas in one or more of the plurality of combustors by controlling one or more operating parameters of the fuel-air mixture. Thus, the control system 30 includes hardware and software for monitoring the velocity of the hot gas, monitoring an operating parameter, and adjusting the operating parameter, as discussed. Such hardware and software may include sensors and other suitable measurement devices as well as suitable programs for calculating hot gas velocity, various parameters, and changes thereof.

In some embodiments, an operating parameter may be fuel-air ratio. Thus, the amount of fuel and/or the amount of air being provided to a combustor 20 to form the fuel-air mixture may be adjusted by the control system 30 as required to adjust the velocity of the hot gas in the combustor. For example, the amount of fuel supplied could be increased or decreased and/or the amount of air supplied could be increased or decreased as required.

In other embodiments, an operating parameter may be fuel-air mixture composition. Thus, the composition of the fuel being provided to a combustor 20 to form the fuel-air mixture may be adjusted by the control system 30 as required to adjust the velocity of the hot gas in the combustor. For example, the amount of natural gas, oil, hydrogen, fuels containing relatively high amounts of hydrocarbons, fuels having relatively high lower heating values, and/or other suitable liquids or gases that make up the fuel may be increased or decreased as required.

In still other embodiments, an operating parameter may be fuel-air mixture velocity. Thus, the velocity of the fuel, the air, or the combined fuel-air mixture may be adjusted by the control system 30 as required to adjust the velocity of the hot gas in the combustor. For example, the velocity of the fuel, the air, or the combined fuel-air mixture may be increased or decreased as required.

In still other embodiments, an operating parameter may be turbine load, exhaust gas temperature, exhaust gas composition, compressor air pressure, compressor temperature, combustion temperature, combustion noise frequency, combustion noise amplitude, combustion noise velocity, and/or combustion noise acceleration.

It should be understood that the operating parameters of the present disclosure are not limited to the above disclosed examples, and rather that any suitable operating parameter of the fuel-air mixture that may be correlated to the velocity of the hot gas in a combustor 20 and adjusted to adjust the velocity of the hot gas in a combustor 20 are within the scope and spirit of the present disclosure.

The system 10 may further include various devices connected to the combustor section 20 to adjust one or more operating parameters as required by the control system 30. Each device is thus communicatively coupled to the control system 30 and controlled thereby.

For example, in some embodiments, the system 10 may include a humidifier 32. The humidifier 32 may be connected to the fuel source 22 and/or to the air flowing from the compressor 12 to the combustor 14, as shown in FIG. 1, and/or directly to the combustor section 14 as shown in FIG. 2. For example, in some embodiments wherein the humidifier 32 is directly connected to the combustor section 14, the humidifier 32 may be directly connected to one or more injectors, or through the outer casing, discussed below, or otherwise, of one or more of combustors 20. The humidifier 32 may add water and/or steam to the air-fuel mixture as desired or required to adjust an operating parameter thereof.

In other embodiments, the system 10 may include an exhaust gas recirculation device 34. The exhaust gas recirculation device 34 may be connected to the fuel source 22, as shown in FIG. 1, and/or directly to the combustor section 14 as shown in FIG. 2. For example, in embodiments wherein the exhaust gas recirculation device 34 is directly connected to the combustor section 14, the exhaust gas recirculation device 34 may be directly connected to one or more injectors, or through the outer casing, discussed below, or otherwise, of one or more of combustors 20. The exhaust gas recirculation device 34 may further be connected to a HRSG 26, or may be directly connected to the exhaust from the generator 24. The exhaust gas recirculation device 34 may add exhaust gas exhausted from the generator 24 to the air-fuel mixture as desired or required to adjust an operating parameter thereof.

In still other embodiments, the system 10 may include an inert gas circulation device 36. The inert gas circulation device 36 may be connected to the fuel source 22, as shown in FIG. 1, and/or directly to the combustor section 14 as shown in FIG. 2. For example, in embodiments wherein the inert gas circulation device 36 is directly connected to the combustor section 14, the inert gas circulation device 36 may be directly connected to one or more injectors, or through the outer casing, discussed below, or otherwise, of one or more of combustors 20. The inert gas circulation device 36 may add an inert gas, such as helium, neon, argon, krypton, xenon, radon, sulfur, hexaflouride, nitrogen, or any other suitable inert gas, to the air-fuel mixture as desired or required to adjust an operating parameter thereof.

One or more of the combustors 20 may further include various novel features that may be arranged to allow for control of the velocity of the hot gas therein. As shown in FIG. 3 through 7, a combustor 20 according to the present disclosure may include an outer shell 40 defining a chamber 42 therein. A combustor 20 may further include one or more injectors 44. Each injector 44 injects a fuel into the chamber 42. Thus, each injector 44 may be connected to the outer shell 40 and extend therethrough, and further connected to the fuel source 22, thus placing the fuel source 22 and combustor in fluid communication for flowing fuel therethrough. Further, it should be understood that the fuel injected by each injector 44 into the chamber 42 of a combustor 20 may have a composition and/or velocity that is identical to or different from those of any other injectors 44 in the combustor 20 and/or combustion section 14.

Thus, in some embodiments, a combustor 20 may include a plurality of injectors 44. One or more of the injectors 44 may be positioned adjacent to an inlet 46 of the combustor 20. Another one or more of the injectors 44 may be downstream injectors 48, which are injectors positioned downstream of the inlet 46 to provide late injection of fuel into the combustor 20.

A combustor 20 according to the present disclosure may further be in fluid communication with the compressor section 12 for flowing air to each of the plurality of chambers 42. For example, the outer casing 40 or other suitable component of the combustor 20 may define one or more apertures 50. The apertures 50 may allow air flowing from the compressor 12 through a plenum 52 surrounding the combustor 20 therethrough and into the chamber 42 for mixing with the fuel to form a fuel-air mixture.

A combustor 20 according to the present disclosure may further advantageously include a plurality of venturi nozzles 60. A venturi nozzle 60 is a nozzle that includes a restricted portion 62 as well as an upstream portion 64 and/or a downstream portion 66. Further upstream portion 64 and/or downstream portion 66 generally taper to the restricted portion 62 such that the restricted portion has a generally smaller cross-sectional area, thus causing a flow therethrough to have a lower pressure and higher velocity within the restricted portion. Each venturi nozzle 60 is positioned in the combustor 20, such as at least partially in the chamber 42 of the combustor 20, for flowing fuel, air, or the fuel-air mixture therethrough. For example, a venturi nozzle 60 according to the present disclosure may be coupled to an injector 44 for flowing fuel therethrough, or may be positioned adjacent to one or more apertures for flowing air therethrough, or may be generally positioned within a chamber 42 for flowing a fuel-air mixture therethrough.

In some embodiments, at least a portion of the venturi nozzles 60 may be arranged in an annular array, such as generally about the circumference of the chamber 42 as shown in FIGS. 4, 6 and 7. One or more of the annular array of venturi nozzles 60 may be coupled to an injector 44, such as an injector 44 adjacent inlet 46 or a downstream injector 48, and may thus flow fuel therethrough. Additionally or alternatively, one or more of the annular array of venturi nozzles 60 may be coupled to an aperture 50 and may thus flow air therethrough.

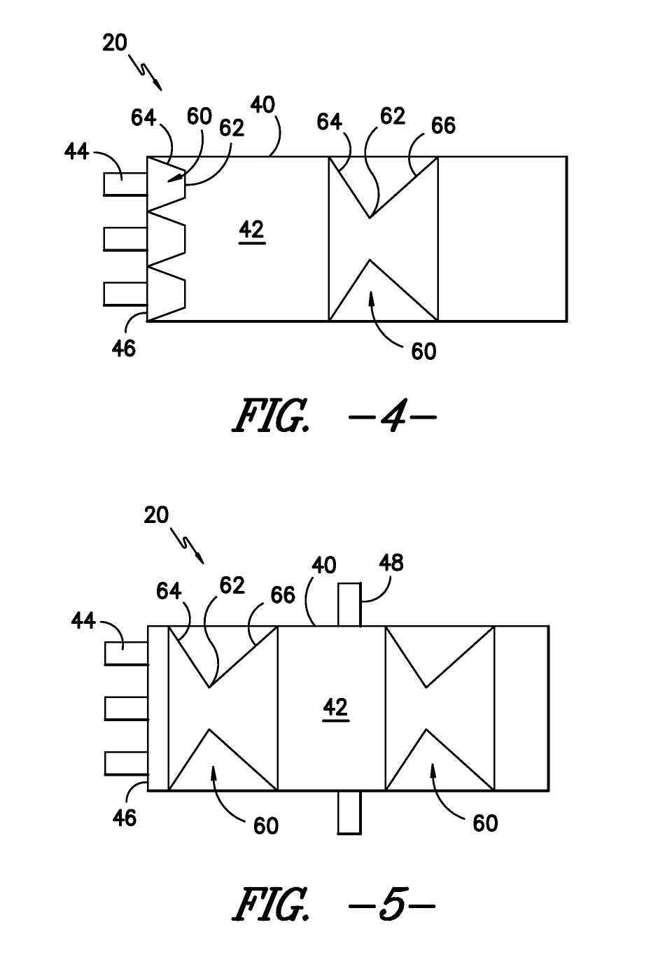

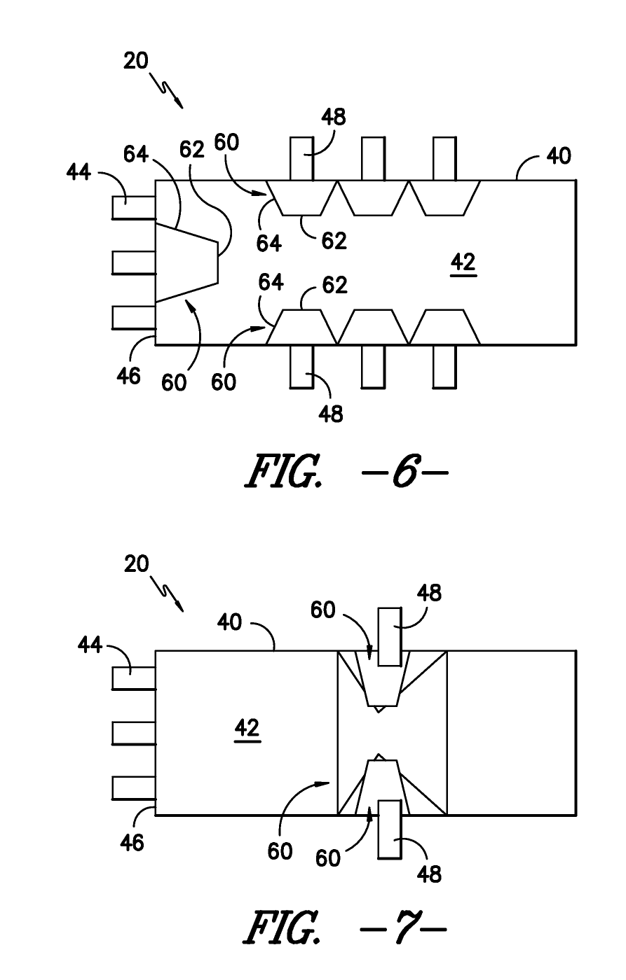

In other embodiments, at least a portion of the venturi nozzles 60 are arranged in an axial array, such as along a portion of the chamber 42 as shown in FIGS. 5 and 6. One or more of the axial array of venturi nozzles 60 may be coupled to an injector 44, such as an injector adjacent inlet 46 or a downstream injector 48, and may thus flow fuel therethrough. Additionally or alternatively, one or more of the axial array of venturi nozzles 60 may be coupled to an aperture 50 and may thus flow air therethrough.

For example, FIG. 4 illustrates a plurality of venturi nozzles 60 arranged in an annular array adjacent inlet 46. One or more of these venturi nozzles 60 may be coupled to an injector 48. An additional venturi nozzle 60 is positioned downstream of this annular array, as shown. This venturi nozzle 60 flows fuel and/or air within the chamber 42 therethrough.

FIG. 5 illustrates a plurality of venturi nozzles 60 arranged in an axial array. One venturi nozzle 60 may be positioned adjacent inlet 46, and may be coupled to an injector 48. Another is positioned downstream, as shown. This venturi nozzle 60 flows fuel and/or air within the chamber 42 therethrough.

FIG. 6 illustrates a plurality of venturi nozzles 60 arranged in annular and axial arrays. One venturi nozzle 60 may be positioned adjacent inlet 46, and may be coupled to an injector 48. Others are positioned downstream, and may be coupled to downstream injectors 48.

FIG. 7 illustrates a plurality of venturi nozzles 60 arranged in an annular array. Various of these may be coupled to downstream injector 48. An additional venturi nozzle 60 may be positioned downstream and in communication with the annular array, for flowing fuel and/or air within the chamber 42 therethrough.

The present disclosure is further directed to a method for controlling combustion instability in a combustion section 14 and combustor 20 of a gas turbine system 10. The method includes, for example, determining a velocity of a hot gas in the combustor, and adjusting one or more operating parameters of the fuel-air mixture that is provided to the combustor and ignited into the hot gas. Such adjustment according to the present disclosure may effect a change in velocity, which may result in control of combustion instabilities, as discussed. The operating parameters may include, for example, fuel-to-air ratio, fuel-air mixture composition, fuel-air mixture velocity, turbine load, exhaust gas temperature, exhaust gas composition, compressor air pressure, compressor temperature, combustion temperature, combustion noise frequency, combustion noise amplitude, combustion noise velocity, and/or combustion noise acceleration.

In some embodiments, the adjusting step includes operating a humidifier 32 connected to the combustor section 20, as discussed above. In other embodiments, the adjusting step includes operating an exhaust gas recirculation device 34 connected to the combustor section 20, as discussed above. In still other embodiments, the adjusting step includes operating an inert gas circulation device 36 connected to the combustor section 20, as discussed above.

Additionally, in some embodiments, a combustor according to the present method includes a plurality of venturi nozzles 60, as discussed above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A gas turbine system comprising:
a compressor section;
a turbine section connected to the compressor section;
a combustor section connected to the compressor section and the turbine section, the combustor section comprising a plurality of combustors, each of the plurality of combustors comprising an outer shell defining a chamber therein, each of the plurality of combustors in fluid communication with the compressor section for flowing air to each of the plurality of chambers and further comprising at least one injector for injecting a fuel into the chamber such that the air and fuel form an air-fuel mixture, the combustor section further comprising at least one igniter for igniting the fuel-air mixture within each of the plurality of combustors into a hot gas; and
a control system for controlling a velocity of the hot gas in at least one of the plurality of combustors by controlling an operating parameter of the fuel-air mixture.

2. The gas turbine system of claim 1, wherein the operating parameter is one of fuel-to-air ratio, fuel-air mixture composition, or fuel-air mixture velocity.

3. The gas turbine system of claim 1, wherein the control system comprises a humidifier connected to the combustor section.

4. The gas turbine system of claim 3, wherein the humidifier is directly connected to at least one of the plurality of combustors.

5. The gas turbine system of claim 1, wherein the control system comprises an exhaust gas recirculation device connected to the combustor section.

6. The gas turbine system of claim 5, wherein the exhaust gas recirculation device is directly connected to at least one of the plurality of combustors.

7. The gas turbine system of claim 1, wherein the control system comprises an inert gas circulation device connected to the combustor section.

8. The gas turbine system of claim 7, wherein the inert gas circulation device is directly connected to at least one of the plurality of combustors.

9. The gas turbine system of claim 1, wherein at least one of the plurality of combustors further comprises a plurality of venturi nozzles.

10. The gas turbine system of claim 9, wherein the at least one of the plurality of combustors further comprises a plurality of injectors.

11. The gas turbine system of claim 10, wherein at least a portion of the plurality of venturi nozzles are arranged in an annular array adjacent to an inlet of the combustor, and wherein each of the portion of the plurality of venturi nozzles is coupled to one of the plurality of injectors.

12. The gas turbine system of claim 10, wherein at least a portion of the plurality of venturi nozzles are arranged in an axial array.

13. The gas turbine system of claim 12, wherein each of the portion of the plurality of venturi nozzles is coupled to one of the plurality of injectors.

14. The gas turbine system of claim 9, wherein at least a portion of the plurality of injectors are downstream injectors.

15. A method for controlling combustion instability in a combustor section of a gas turbine system, the combustor section comprising a combustor, the combustor comprising an outer shell defining a chamber therein, the combustor in fluid communication with a compressor section of the turbine system for flowing air to the chamber and further comprising at least one injector for injecting a fuel into the chamber such that the air and fuel form an air-fuel mixture, the combustor section further comprising at least one igniter for igniting the fuel-air mixture within the combustor into the hot gas, the method comprising:
determining a velocity of a hot gas in a combustor of the combustion section; and
adjusting an operating parameter of the fuel-air mixture.

16. The method of claim 15, wherein the operating parameter is one of fuel-to-air ratio, fuel-air mixture composition, or fuel-air mixture velocity.

17. The method of claim 15, wherein the adjusting step comprises operating a humidifier connected to the combustor section.

18. The method of claim 15, wherein the adjusting step comprises operating an exhaust gas recirculation device connected to the combustor section.

19. The method of claim 15, wherein the adjusting step comprises operating an inert gas circulation device connected to the combustor section.

20. The method of claim 15, wherein the combustor further comprises a plurality of venturi nozzles.
